(19) United States
(12) Patent Application Publication
(10) Pub. No.: US 2026/0368983 A1
(43) Pub. Date: Nov. 19, 2026

(54) INFORMATION PROCESSING APPARATUS, INFORMATION PROCESSING METHOD, AND RECORDING MEDIUM

(71) Applicant: Sony Group Corporation, Tokyo (JP)

(72) Inventor: Seiji KIMURA, Chiba (JP)

(73) Assignee: Sony Group Corporation, Tokyo (JP)

(21) Appl. No.: 19/158,797

(22) PCT Filed: Feb. 13, 2024
(86) PCT No.: PCT/JP2024/004713

§ 371 Date: Aug. 21, 2025

(30) Foreign Application Priority Data
Mar. 27, 2023 (JP) 2023-050084

(51) Int. Cl. G06T 13/20; G06T 13/40

(52) U.S. Cl. CPC G06T 13/205; G06T 13/40

(57) ABSTRACT

[Solving Means] In order to accomplish the above-mentioned objective, a division unit and a correction unit are provided. The inference unit infers gesture information related to a gesture by inputting voice data to a learned model. The division unit divides the gesture information into a high-frequency component that represents a beat gesture corresponding to a conversation rhythm and a low-frequency component that represents a gesture different from the beat gesture. The correction unit generates corrected gesture information by correcting at least one of the high-frequency component or the low-frequency component on the basis of a correction parameter. Accordingly, diverse expressions of gestures and an improvement in control accuracy of the gestures become possible.

### TECHNICAL FIELD

The present technology relates to an information processing apparatus, an information processing method, and a recording medium that can be applied to generation of an animation of human motions and the like.

### BACKGROUND ART

Conventionally, a technology of changing a mouth motion on the basis of a voice is known (see Patent Literature 1). However, there is a problem in that when attempting to generate a motion of a part other than the face on the basis of a voice, different motions are generated on the basis of the same speech voice, which is called OnetoMany problem, and the output of inference processing is likely to be an average motion of learning data. Moreover, as shown in Table 2 of Patent Literature 1, a classification method using Iconic, Metaphoric, Beats, Deictic, and Emblem as labels for gesture classification is well-known.

Also, as in Non-Patent Literature 1, diverse motions are generated by devising data sets, network configuration, and the like. However, in Non-Patent Literature 1, big learning data is required, the network configuration is more complicated, and it takes a lot of time to learn. Moreover, even if diverse motions can be generated, a desired motion cannot be always obtained, and it is difficult to improve the control accuracy of generated motion data.

### CITATION LIST

### Patent Literature

Patent Literature 1: Japanese Patent Application Laid-open No. 2020-6482

### Non-Patent Literature

Non-Patent Literature 1: “Speech 6Drives Templates: Co-Speech Gesture Synthesis with Learned Templates” (ICCV2021)

### DISCLOSURE OF INVENTION

### Technical Problem

Thus, it is desirable to provide an information processing apparatus, an information processing method, and a recording medium describing a program, which are capable of realizing diverse expressions of gestures and an improvement in control accuracy of the gestures when generating a human motion on the basis of a voice.

In view of the above-mentioned circumstances, it is an objective of the present technology to provide an information processing apparatus, an information processing method, and a recording medium, which are capable of realizing diverse expressions of gestures and an improvement in control accuracy of the gestures.

### Solution to Problem

In order to accomplish the above-mentioned objective, an information processing apparatus according to an embodiment of the present technology includes an inference unit, a division unit, and a correction unit.

The inference unit infers gesture information related to a gesture by inputting voice data to a learned model.

The division unit divides the gesture information into a high-frequency component that represents a beat gesture corresponding to a conversation rhythm and a low-frequency component that represents a gesture different from the beat gesture.

The correction unit generates corrected gesture information by correcting at least one of the high-frequency component or the low-frequency component on the basis of a correction parameter.

In this information processing apparatus, gesture information related to a gesture is inferred by inputting voice data to a learned model and is divided into a high-frequency component that represents a beat gesture corresponding to a conversation rhythm and a low-frequency component that represents a gesture different from the beat gesture. Moreover, corrected gesture information is generated by correcting at least one of the high-frequency component or the low-frequency component on the basis of a correction parameter. Accordingly, diverse expressions of gestures and an improvement in control accuracy of the gestures become possible.

The information processing apparatus may further include a reproduction control unit that synchronizes the corrected gesture information with the voice data and causes an avatar to perform the gesture based on the corrected gesture information.

The correction parameter may include at least one of an emphasis degree indicating a degree of emphasizing the beat gesture, replacement information that causes the avatar to perform a predetermined gesture, or collision information related to a collision of the avatar.

The correction unit may emphasize the beat gesture on the basis of the emphasis degree.

The correction unit may add the beat gesture emphasized on the basis of the emphasis degree to a gesture represented by the low-frequency component.

The correction unit may replace a gesture represented by the low-frequency component on the basis of the replacement information.

A gesture represented by the low-frequency component may include a gesture accompanied by speech and a gesture indicating a feature of a time direction or a spatial direction.

The information processing apparatus may further include a setting unit that sets speech information related to a speaker who utters speech on the basis of the voice data.

The speech information may include at least one of an emotion of the speaker in the speech, a sentiment of the speaker in the speech, a keyword included in the speech, or a character of the speaker in the speech.

The information processing apparatus may further include a control unit that controls a correction parameter on the basis of the speech information. In this case, the control unit may control an emphasis degree on the basis of at least one of the emotion, the sentiment, or the character.

The control unit may control a timing of replacing a gesture represented by the low-frequency component on the basis of a timing at which the keyword is uttered.

The information processing apparatus may further include a detection unit that determines whether the avatar is colliding. In this case, the collision information may include information as to whether or not the avatar is colliding and information about a position where the collision is occurring.

The correction unit may attenuate the emphasis degree so that the collision does not occur on the basis of the collision information.

An information processing method according to an embodiment of the present technology is an information processing method executed by a computer system and includes inferring gesture information related to a gesture by inputting voice data to a learned model.

The gesture information is divided into a high-frequency component that represents a beat gesture corresponding to a conversation rhythm and a low-frequency component that represents a gesture different from the beat gesture. Corrected gesture information is generated by correcting at least one of the high-frequency component or the low-frequency component on the basis of a correction parameter.

A recording medium recording a program according to an embodiment of the present technology causes a computer system to execute the following steps.

A step of inferring gesture information related to a gesture by inputting voice data to a learned model.

A step of dividing the gesture information into a high-frequency component that represents a beat gesture corresponding to a conversation rhythm and a low-frequency component that represents a gesture different from the beat gesture.

A step of generating corrected gesture information by correcting at least one of the high-frequency component or the low-frequency component on the basis of a correction parameter.

### BRIEF DESCRIPTION OF DRAWINGS

FIG. 1 A block diagram showing a configuration example of an information processing apparatus according to a first embodiment.

FIG. 2 A block diagram showing a configuration example of a learning unit.

FIG. 3 A block diagram showing a configuration example of a voice data processing unit.

FIG. 4 A block diagram showing a configuration example of an inference unit.

FIG. 5 A block diagram showing a configuration example of a division unit.

FIG. 6 A block diagram showing a configuration example of an emphasis unit.

FIG. 7 A block diagram showing a configuration example of a beat gesture attenuation unit.

FIG. 8 A block diagram showing a configuration example of a speech information setting unit.

FIG. 9 A schematic diagram showing an example of speech division.

FIG. 10 A block diagram showing a configuration example of a motion generation unit.

FIG. 11 A block diagram showing a configuration example of an emphasis degree setting unit.

FIG. 12 A block diagram showing a configuration example of a motion determination unit.

FIG. 13 A block diagram showing a configuration example of a pose information setting unit.

FIG. 14 A block diagram showing a configuration example of a motion clip setting unit.

FIG. 15 A block diagram showing a configuration example of a reproduction control unit.

FIG. 16 A block diagram showing a configuration example of an information processing apparatus according to a second embodiment.

FIG. 17 A block diagram showing a configuration example of a voice synthesis unit.

FIG. 18 A block diagram showing a configuration example of a speech information setting unit.

FIG. 19 A block diagram showing a configuration example of an information processing apparatus according to a third embodiment.

### MODE(S) FOR CARRYING OUT THE INVENTION

Hereinafter, embodiments according to the present technology will be described with reference to the drawings.

### First Embodiment

### [Configuration of Information Processing Apparatus]

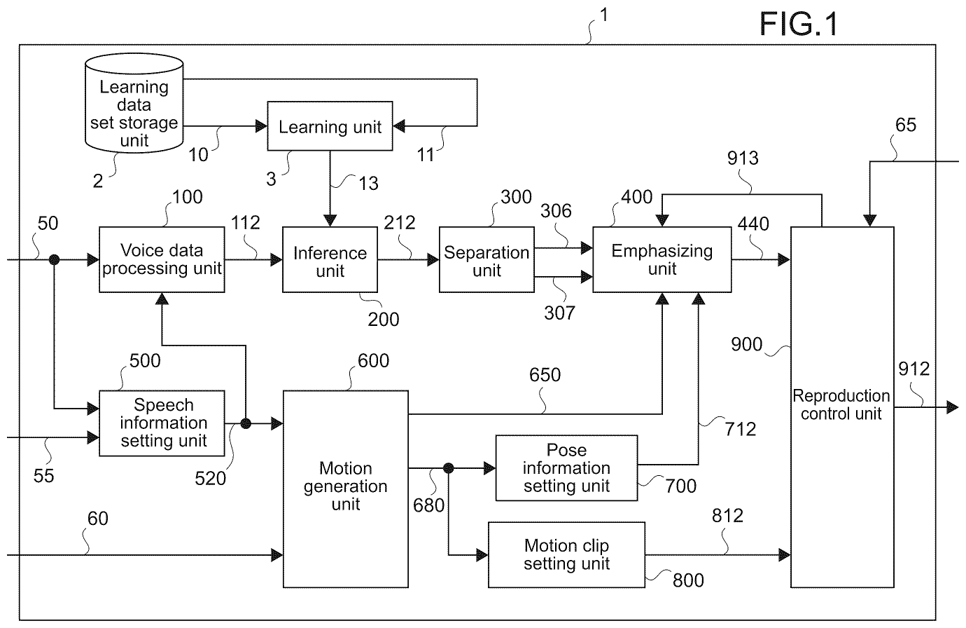

FIG. 1 is a block diagram showing a configuration example of an information processing apparatus 1 according to a first embodiment of the present technology.

The information processing apparatus 1 includes a learning data set storage unit 2 and a learning unit 3 for generating a learning model and a voice data processing unit 100 and an inference unit 200, a division unit 300, an emphasis unit 400, a speech information setting unit 500, a motion generation unit 600, a pose information setting unit 700, a motion clip setting unit 800, and a reproduction control unit 900 for performing inference processing.

The learning data set storage unit 2 stores voice data and motion information. In the present embodiment, the motion information is obtained in synchronization with the voice data and is processed to be subdivided into a suitable data size for learning processing. The learning data set storage unit 2 stores the voice data and the motion information as a paired data set.

The motion information includes motions of various parts, such as the face, head, arms, hands, and legs of a person. It should be noted that the motion information is not limited to the motion expressed in a three-dimensional space, and may be expressed as a two-dimensional motion projected on a 2D video. Moreover, a method of expressing the motion is not limited, and it may be represented as time-series data of coordinate values or may be represented as time-series data of angles of bones corresponding to joints.

It should be noted that the motion information is not limited to the particular part or bone structure. Moreover, a method of obtaining the motion information is not limited, and dedicated devices and detection techniques may be additionally used. For example, motion capture with a dedicated suit may be performed.

It should be noted that the voice data may be obtained by a sound pickup device such as a microphone. Moreover, the voice data may be subjected to various types of voice signal processing such as noise addition and pitch adjustment for data augmentation. It should be noted that in a case where the time of the voice data changes, the length of the motion information is changed in accordance with its length. Moreover, in a case of a learning unit to be described later performs mini-batch learning, the voice data may be read out in mini-batch sizes (e.g., 32).

The learning unit 3 reads out voice data 10 and motion information 11 in a necessary data size, such as a mini-batch size, from the learning data set storage unit 2 as learning data and performs learning processing.

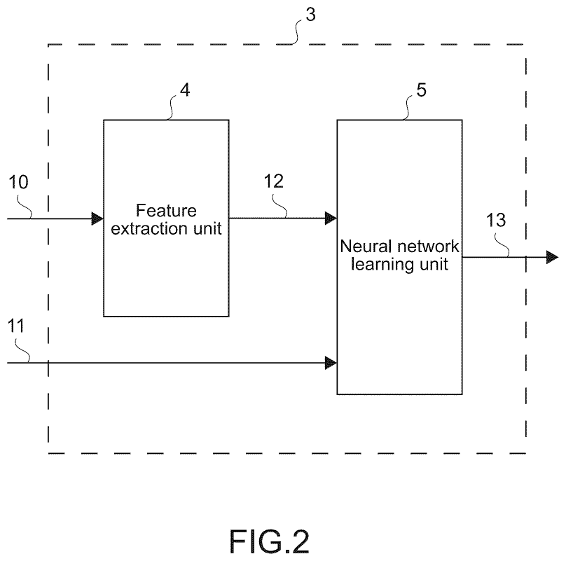

FIG. 2 is a block diagram showing a configuration example of the learning unit 3.

As shown in FIG. 2, the learning unit 3 includes a feature extraction unit 4 and a neural network learning unit 5.

The feature extraction unit 3 extracts feature information 12 representing a feature of the voice from the voice data 10. It should be noted that a method for extracting the feature information 12 is not limited, and may be an expression using pitch or energy or may be expressed as a mel-frequency spectrogram, a mel-frequency cepstral coefficient (MFCC), or the like considering human sound perception. The feature information 12 is output to the neural network learning unit 5.

The neural network learning unit 5 learns as a regression problem of conversion from the feature information 12 to the motion information. For example, a convolutional neutral network (CNN) such as U-Net may be used or a recurrent neutral network (RNN) such as LSTM may be used as a network architecture.

In the present embodiment, the loss function for the time-series data of the motion information is set using both in-frame information at a certain point in time and inter-frame information at different points in time, or either one of them. Moreover, the loss function may be set considering a generative adversarial network (GAN).

By this learning processing, a motion generation model 13 of a neural network capable of generating a human motion on the basis of an input voice is generated. The motion generation model 13 is output to the inference unit 200.

The voice data processing unit 100 performs processing such as data size adjustment on input voice test data 50. For example, the voice test data 50 is an actual voice and is obtained by a sound pickup device such as a microphone. It should be noted that the voice test data 50 may be in an audio file format recorded in advance or may be streaming data transmitted in any means.

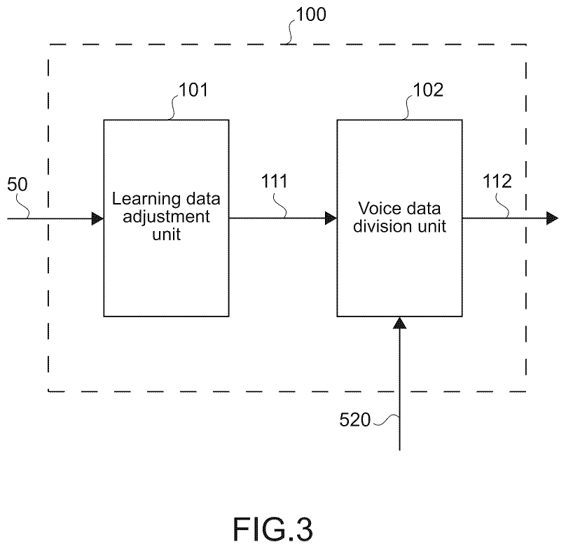

FIG. 3 is a block diagram showing a configuration example of the voice data processing unit 100.

As shown in FIG. 3, the voice data processing unit 100 includes a learning data adjustment unit 101 and a voice data division unit 102.

The learning data adjustment unit 101 applies voice signal processing to the input voice test data 50. For example, adjustment is performed to be adapted to characteristics of the learning data (voice data and motion information) used in the motion generation model 13. Moreover, the voice signal processing includes, for example, noise reduction processing, band limiting processing, and sound volume normalization processing. Moreover, in a case where the learning data is a voice of a particular person, voice conversion processing using deep learning may be applied and voice signal processing may be performed to approximate the voice quality of the speaker used in the learning data.

The voice data division unit 102 divides voice test data 111 adjusted on the basis of speech information 520 output from the speech information setting unit 500 to be described later.

Voice test data 112 subjected to processing by the learning data adjustment unit 101 and the voice data division unit 102 is output to the inference unit 200.

The inference unit 200 performs inference processing on the basis of the motion generation model 13 output by the learning unit 3. In the present embodiment, the inference unit 200 infers motion generation data 212 including time-series data of a pose of a human skeleton by receiving the input of the voice test data 112 and the motion generation model 13. Moreover, the motion generation data 212 outputs it to the division unit 300.

Here, the motion generation data 212 includes a motion done for representing an intension of the speaker or emphasizing the conversation. The motion includes a gesture of making a particular motion. It should be noted that in the present disclosure, the motion done for representing an intension of the speaker or emphasizing the conversation may be referred to as a gesture for the sake of distinction.

Gestures are classified into motions defined by convention, such as OK sign and numbers, emblems, which have characteristics that differ depending on the society in terms of shape and meaning, and spontaneous gestures. The spontaneous gestures are gestures whose shape and meaning are not completely defined by convention, and gestures that occur naturally with speech.

In the present embodiment, the spontaneous gestures are classified into beat gestures and emblematic gestures.

The beat gesture indicates a gesture corresponding to a conversation rhythm. For example, the beat gesture includes a gesture of expressing an emphasized speech, a motion of creating rhythms by moving the hands rapidly, a motion of rhythmically moving the body up and down and right and left, and the like. That is, the beat gesture can also be said to be a gesture unrelated to the speech contents or a gesture that does not change in shape in accordance with the speech contents.

The emblematic gesture is a gesture indicating a feature in a time direction or a spatial direction. The emblematic gesture is classified into a iconic gesture that expresses the shape and size of an object, a metaphoric gesture that expresses an abstract concept, and a deictic gesture that is a motion indicating a certain direction, location, or matter (see Table 2 in Japanese Patent Application Laid-open No. 2020-6482).

It should be noted that the motion generation data 212 in the present embodiment corresponds to gesture information related to a gesture.

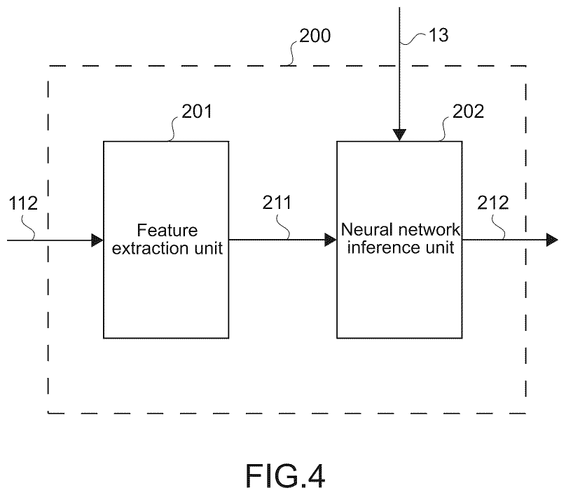

FIG. 4 is a block diagram showing a configuration example of the inference unit 200.

As shown in FIG. 4, the inference unit 200 includes a feature extraction unit 201 and a neural network inference unit 202.

The feature extraction unit 201 extracts feature information 211 representing the feature of the voice from the voice test data 112 output from the voice data processing unit 100. It should be noted that a method for extracting the feature information 211 is not limited, and may be an expression using pitch or energy or may be expressed as a mel-frequency spectrogram, a mel-frequency cepstral coefficient (MFCC), or the like considering human sound perception. The feature information is output to the neural network inference unit 202.

The neural network inference unit 202 infers the motion generation data 212 from the feature information 211. In the present embodiment, the neural network inference unit 202 is constituted by a network architecture corresponding to the neural network learning unit 5 and parameters of an inference network is set from the motion generation model 13. By inputting the feature information to this inference network, the motion generation data 212 is generated.

The division unit 300 divides the motion generation data 212 into a low-frequency component and a high-frequency component in the time direction. In the present embodiment, the division unit 300 divides the motion generation data 212 so that the beat gestures are a high-frequency component and the emblems and the emblematic gestures are a low-frequency component. That is, gestures other than the beat gestures are divided as the low-frequency component.

Also, in the present embodiment, emblem and emblematic gesture (hereinafter, referred to as low-frequency information 306) that are the low-frequency component and a beat gesture 307 that are the high-frequency component are output to the emphasis unit 400.

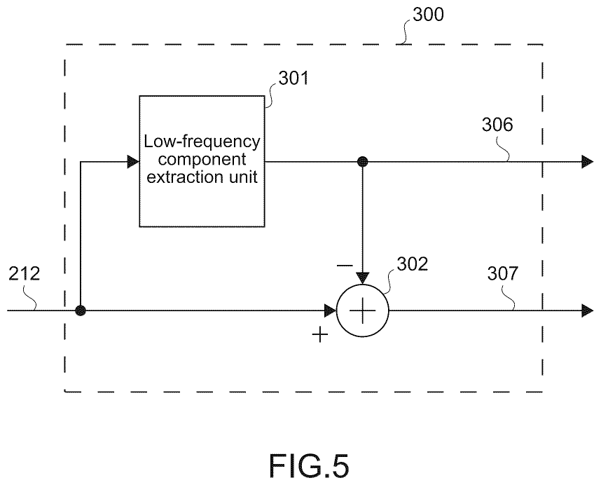

FIG. 5 is a block diagram showing a configuration example of the division unit 300.

As shown in FIG. 5, the division unit 300 includes a low-frequency component extraction unit 301 and an adder 302.

The low-frequency component extraction unit 301 applies the low pass filter in the time direction to the time-series data of the pose of the human skeleton shown in the motion generation data 212 input and outputs the low-frequency component of the motion data as the low-frequency information 306.

The adder 302 subtracts the time-series data indicating the low-frequency information 306 from the motion generation data 212, thereby determining the high-frequency component (beat gesture 307) of the motion data.

It should be noted that a mean filter, a Gaussian filter, or the like may be applied as the low pass filter.

The low-frequency information 306 and the beat gesture 307, a beat gesture emphasis degree 650 output from the motion generation unit 600 to be described later, pose information 712 output from the pose information setting unit 700 to be described later, and collision information 913 output from the reproduction control unit 900 to be described later and input to the emphasis unit 400.

Also, the emphasis unit 400 performs emphasizing processing on the beat gesture 307 on the basis of the beat gesture emphasis degree 650. Moreover, the emphasis unit 400 adds the beat gesture subjected to the emphasizing processing to a gesture of the low-frequency component, which is set by the low-frequency information 306 or the pose information 712. In the present embodiment, the motion of the low-frequency component (hereinafter, referred to as post-motion generation information 440) to which the beat gesture subjected to the emphasizing processing has been added is output to the reproduction control unit 900.

Here, the pose information 712 is information indicating what type of pose a 3D model is caused to perform when causing the 3D model to perform a predetermined gesture. For example, the pose includes poses (motions) showing various emotions, for example, a pose that represents joy such as raising both hands, a pose that represents anger such as making a fist, a pose that represents fear such as covering the face, a pose that represents surprise such as covering the mouth, a pose that represents dislike such as pointing the finger at a target, or a pose that represents sadness such as hanging one's head with both arms down.

It should be noted that the pose includes a spontaneous motion like a still image and a time-series motion like a video. Moreover, the pose also includes the process of reaching a predetermined motion. For example, the pose also includes a state of standing still with both hands raised and a motion of raising both hands from a lowered position.

It should be noted that the 3D model in the present embodiment refers to model information 65, which is a virtual object to which animation reproduction data 912 output from the information processing apparatus 1 is applied. For example, 3D models may be 3DCG assets such as non-photorealistic models such as anime characters or photorealistic models such as digital humans. Moreover, the 3D models are not limited to 3D models, and 2D models may also be used.

The model information 65 is information related to the 3D model that performs gestures. For example, the model information 65 includes mesh data of the shapes of various parts, such as the face, hands, and legs, the positions of joints, such as the height of the knees, and the like and various types of texture data such as albedo, specular, and roughness. In addition, it may also include parts representing features of the model, such as the shapes of hair and clothes and accessories. Moreover, bones may be set for each of the hair, clothes, accessories, and the like, so that physical swaying under collision or gravity is set to occur. Moreover, the direction of rotation and the rotatable angle may be set for each joint, and upper limit values may be set for swaying (moves in various directions) of clothes, such as skirts, and hair.

In the present embodiment, the pose information 712 is set so that identification data indicating low-frequency information, replacement pose data, or data indicating invalidity is applied. It should be noted that in the present embodiment, conversion to a pose prepared (captured) in advance is referred to as replacement. In other words, replacement pose data is data indicating which pose to replace with from among various predetermined poses.

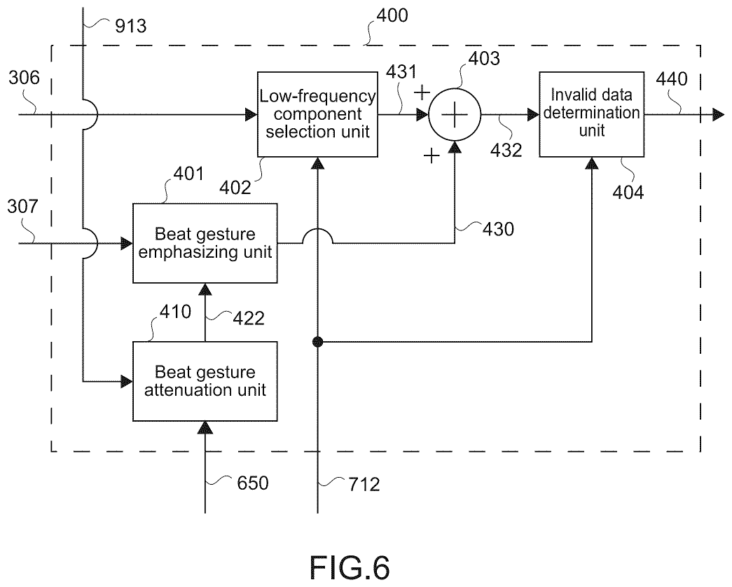

FIG. 6 is a block diagram showing a configuration example of the emphasis unit 400.

As shown in FIG. 6, the emphasis unit 400 includes a beat gesture attenuation unit 410, a beat gesture emphasis unit 401, a low-frequency component selection unit 402, an adder 403, and an invalid data determination unit 404.

The beat gesture attenuation unit 410 performs processing of attenuating the beat gesture emphasis degree 650 with respect to a joint close to a location where the mesh collision has occurred on the basis of the collision information 913 output from the reproduction control unit 900 to be described later.

The collision information 913 is information related to a collision with a model or a collision between other objects. In the present embodiment, the collision information 913 includes whether or not there are collisions of meshes that cause artifacts such as fingers or clothes passing through each other, and the locations where such collisions occur.

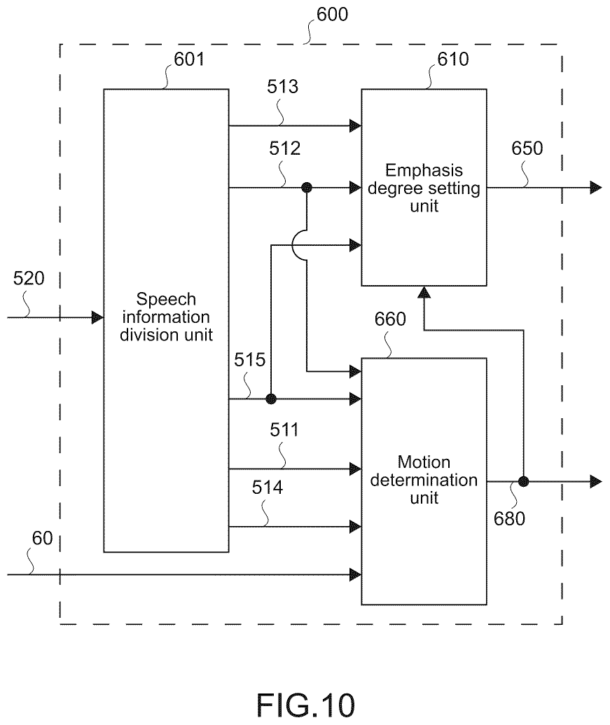

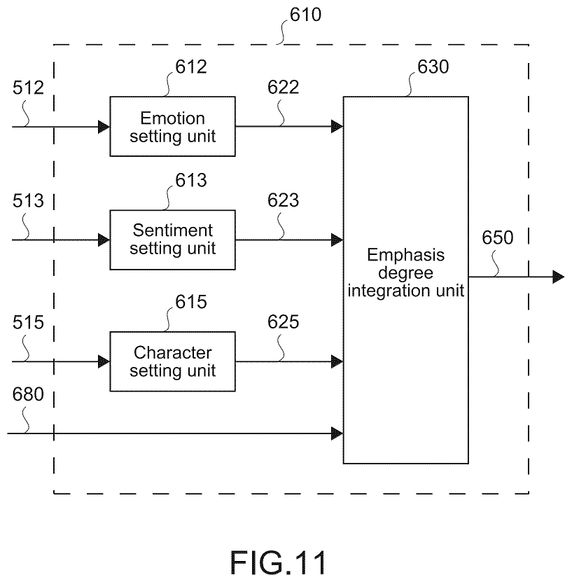

The beat gesture emphasis degree 650 indicates the degree of emphasizing the beat gesture. A specific setting method will be described in FIGS. 10 and 11.

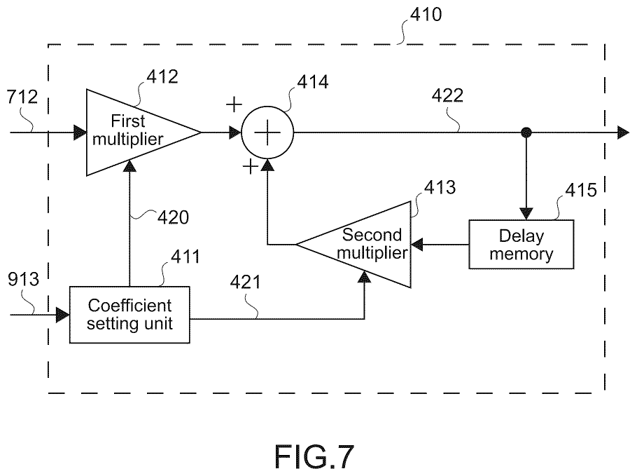

Here, a configuration example of the beat gesture attenuation unit 410 will be described with reference to FIG. 7. FIG. 7 is a block diagram showing a configuration example of the beat gesture attenuation unit 410.

As shown in FIG. 7, the beat gesture attenuation unit 410 includes a coefficient setting unit 411, a first multiplier 412, a second multiplier 413, an adder 414, and a delay memory 415.

The coefficient setting unit 411 sets a coefficient of the beat gesture emphasis degree output to the first multiplier 412 and the second multiplier 413 on the basis of the collision information 913. In the present embodiment, in a case where a predetermined joint is close to the location where the mesh collision has occurred, the coefficient setting unit 411 sets a coefficient of a beat gesture emphasis degree 420 input to the first multiplier 412 to 0 and sets a coefficient of a beat gesture emphasis degree 421 input to the second multiplier 413 to a value (e.g., 0.9) smaller than 1.

Also, in a case where the predetermined joint is unrelated to the collision of the mesh, the coefficient setting unit 411 sets the coefficient of the beat gesture emphasis degree 420 input to the first multiplier 412 to 1.0 and sets a coefficient of the beat gesture emphasis degree 421 input to the second multiplier 413 to 0.

Also, the second multiplier 413 multiplies the past value in the delay memory 415 in a case where the mesh collision continues to occur over time. In other words, the smaller the coefficient of the beat gesture emphasis degree, the smaller it gradually becomes, and the beat gesture emphasis is attenuated until a point in time at which the mesh collision no longer occurs.

By setting such a coefficient of the beat gesture emphasis degree for all joints, the coefficient of the beat gesture emphasis degree is set unchanged for joints unrelated to mesh collisions, and the coefficient of the beat gesture emphasis degree is set to be smaller for joints close to the location where the mesh collision has occurred. A coefficient of a beat gesture emphasis degree 422 that takes into account this collision information 913 is input to the beat gesture emphasis unit 401.

The beat gesture emphasis unit 401 emphasizes the beat gesture 307 output from the division unit 300 on the basis of the beat gesture emphasis degree 422. In the present embodiment, the value of the beat gesture emphasis degree 422 is multiplied by the time-series data shown by the beat gesture 307. An emphasized beat gesture 430 is output to the adder 403.

The low-frequency component selection unit 402 selects either the low-frequency information 306 or the pose information 712 output from the pose information setting unit 700 to be described later. In the present embodiment, in a case where the identification data indicating the low-frequency information has been set to the pose information 712, the low-frequency component selection unit 402 selects the low-frequency information 306. Moreover, in a case where the replacement pose data has been set to the pose information 712, the low-frequency component selection unit 402 selects the pose information 712. In the present embodiment, data 431 of either the low-frequency information 306 or the pose information 712 is output to the adder 403.

For example, the identification data includes data not included in a pre-set predetermined pose, for example, all rotational angles showing the motion of the joints are set to a value outside a defined range.

The adder 403 adds the emphasized beat gesture 430 to the data 431 (the low-frequency information 306 or the pose information 712) output by the low-frequency component selection unit 402. This added addition information 432 is supplied to an invalid determination unit 404.

In a case where the input pose information 712 is determined as being invalid, the invalid determination unit 404 outputs the data indicating the invalidity (e.g., data to which the all rotational angles showing the motion of the joints have been set to be values outside the defined range) as the post-motion generation information 440. Moreover, in a case where the input pose information 712 is not determined as being invalid, the invalid determination unit 404 outputs the addition information 432 as the post-motion generation information 440.

It should be noted that the data when the pose information 712 is determined as being invalid, and is different from the identification data of the low-frequency information.

It should be noted that the emphasis unit in the present embodiment corresponds to a correction unit that generates corrected gesture information by correcting at least one of the high-frequency component or the low-frequency component on the basis of a correction parameter.

Also, the beat gesture emphasis degree 650, the pose information 712, and the collision information 913 in the present embodiment correspond to a correction parameter.

On the basis of the voice test data 50 and setting information 55 related to a character who has spoken, the speech information setting unit 500 sets the speech information 520 that is information related to an emotion that can be estimated from the speech and to a speaker who speaks, such as a character.

In the present embodiment, the speech information 520 includes information related to the speaker, such as the emotion, the sentiment, the keyword, and the character, and information related to the contents of the speaker's utterance.

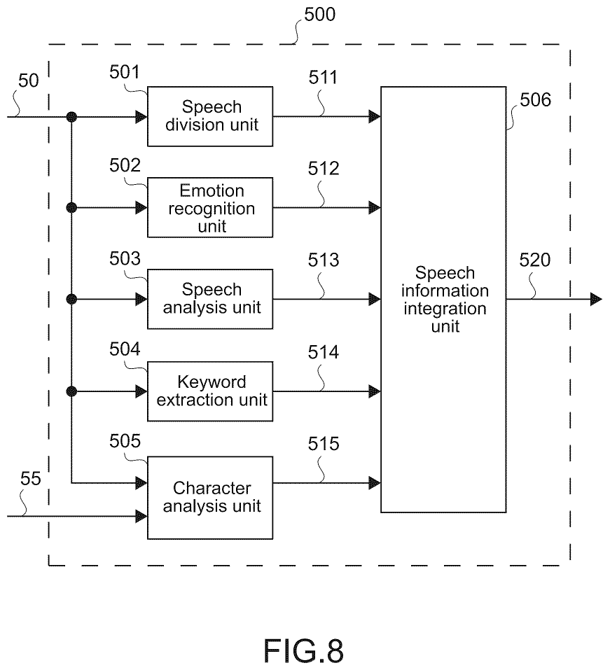

FIG. 8 is a block diagram showing a configuration example of the speech information setting unit 500.

As shown in FIG. 8, the speech information setting unit 500 includes a speech division unit 501, an emotion recognition unit 502, a speech analysis unit 503, a keyword extraction unit 504, a character analysis unit 505, and a speech information integration unit 506.

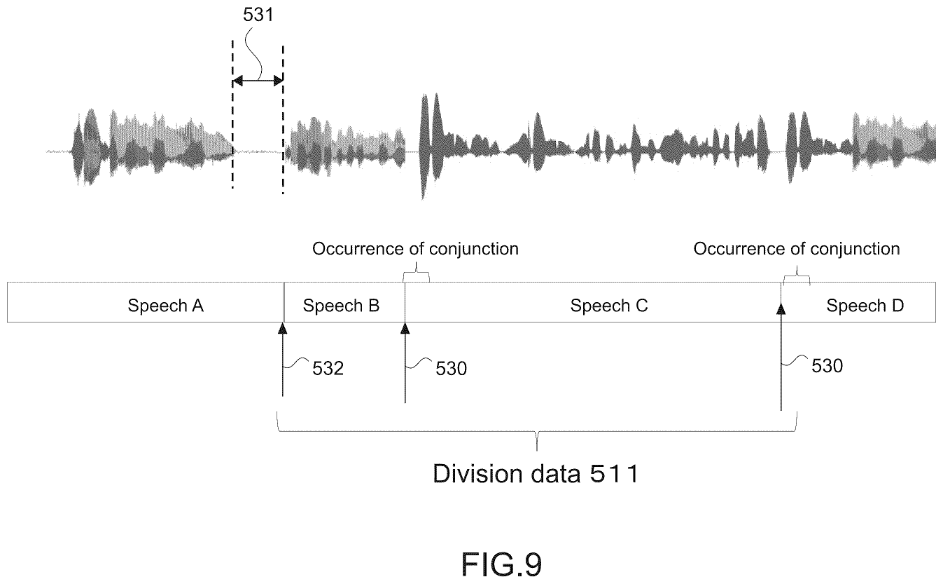

The speech division unit 501 extracts a gesture switching timing with respect to the voice test data 50. Specifically, the speech division is performed using an existing speech division technology based on speech recognition (e.g., “Statistical Language Model for Speech Division in Speech Recognition,” Nakajima et al., Transactions of the Information Processing Society of Japan, 42(11), 2681-2688, 2001-11-15), and the speech time is measured and accumulated for each speech. Moreover, morphological analysis of natural language processing is performed, and the timing of utterance of keywords corresponding to conjunctions and the timing of the end of a silent period exceeding a threshold (see the reference sign 531 in FIG. 9) are extracted.

Moreover, the speech division unit 501 outputs a time code as division data 511 to the speech information integration unit 506 to be described later when one of the following conditions is satisfied: the timing immediately before a conjunction is uttered (see the reference sign 530 in FIG. 9) in a state in which the cumulative speech time exceeds a lower threshold; the timing of the end of the silent period (see the reference sign 532 in FIG. 9) in a state in which the silent period exceeds a predetermined threshold (see the reference sign 531 in FIG. 9); or the timing when the cumulative speech time exceeds the upper threshold.

The emotion recognition unit 502 recognizes the emotion of the speaker from the voice test data 50. For example, the emotion of the speaker includes emotions such as joy, anger, fear, surprise, disgust, or sadness, and is configured by the reliability (0.0 to 1.0) of those emotions. Moreover, a mixture of those emotions (e.g., joy 0.6, surprise 0.3, etc.) is also included in the emotion of the speaker.

It should be noted that the method of recognizing emotions is not limited. For example, a speech emotion recognition technology such as “Recognition of emotions contained in speech” (Acoustical Society of Japan, 71, 484-489 (2015)) may be applied. Moreover, emotion recognition may be performed from text information processed by speech-to-text (e.g., “Multimodal emotion estimation of text and speech 2019,” Morikawa et al., Information Processing Society of Japan Research Report (SLP) (2019)).

In the present embodiment, data including the emotion of the speaker recognized by the emotion recognition unit 502 (hereinafter, referred to as emotion data 512) is output to the speech information integration unit 506.

The speech analysis unit 503 converts the voice test data 50 into text using speech-to-text, and natural language sentiment analysis technology (see, for example, Devlin, J. et al., “BERT: Pre-training of Deep Bidirectional Transformers for Language Understanding” (2018)) is applied to analyze the sentiment of the speech. For example, the sentiment includes states such as positive, negative, or neutral, and is constituted by the reliability (0.0 to 1.0) of those sentiments. Moreover, it also includes a mixture of the above-mentioned sentiments.

In the present embodiment, the data including the sentiment of the speech analyzed by the speech analysis unit (hereinafter, referred to as sentiment data 513) is output to the speech information integration unit 506.

The keyword extraction unit 504 converts the voice test data 50 into text using speech-to-text, performs natural language processing morphological analysis, and extracts pre-registered keywords from interjections such as expressions of emotion, calls, responses, greetings, or shouts, and numerals.

In the present embodiment, the data (hereinafter, referred to as keyword data 514) including the keyword of the speech extracted by the keyword extraction unit 504 is output to the speech information integration unit 506.

The character analysis unit 505 analyzes the character (individuality) of the speaker from the voice test data 50. For example, the character analysis unit 505 analyzes the speech using “Automatic estimation of various personality traits contained in speech,” Journal of the Acoustical Society of Japan, (2015) as a technology for recognizing gender and age from speech, and “Speech Personality Recognition Based on Annotation Classification Using Log-Likelihood Distance and Extraction of Essential Audio Features”, (2021) as a technology of recognizing human personality.

Here, the character of the speaker includes the speaker's age, gender, nationality, Big Five personality traits (openness, agreeableness, conscientiousness, extraversion, and neuroticism), etc., and is constituted by the reliability (0.0 to 1.0) of those characters. Moreover, it also includes a mixture of those characters.

Moreover, in a case where the character of the speaker who is a user is known, the user himself/herself may set setting information 55 related to the character, and the setting information 55 may be input to the character analysis unit. Moreover, the character analysis unit may analyze the character using the voice test data 50 and the setting information 55.

In the present embodiment, data including the character of the speaker analyzed by the character analysis unit 505 (hereinafter, referred to as character data 515) is output to the speech information integration unit 506.

The speech information integration unit 506 outputs information obtained by multiplexing and integrating speech division data 511, the emotion data 512, the sentiment data 513, the keyword data 514, and the character data 515 as the speech information 520.

It should be noted that the speech information setting unit 500 in the present embodiment corresponds to a setting unit that sets the speech information related to the speaker who speaks on the basis of the voice data.

The motion generation unit 600 sets and outputs the beat gesture emphasis degree 650 and motion control information 680 to be described later on the basis of the speech information 520. Specifically, it will be described with reference to FIG. 10.

FIG. 10 is a block diagram showing a configuration example of the motion generation unit 600.

As shown in FIG. 10, the motion generation unit 600 includes a speech information division unit 601, an emphasis degree setting unit 610, and a motion determination unit 660.

The speech information division unit 601 divides the speech information 520 into the speech division data 511, the emotion data 512, the speech analysis unit 503, the sentiment data 513, the keyword data 514, and the character data 515 which are multiplexed.

In the present embodiment, the emotion data 512, the sentiment data 513, and the character data 515 are supplied to the emphasis degree setting unit 610.

Also, in the present embodiment, the speech division data 511, the emotion data 512, the keyword data 514, and the character data 515 are supplied to the motion determination unit 660.

The emphasis degree setting unit 610 sets the beat gesture emphasis degree 650 on the basis of the emotion data 512, the sentiment data 513, and the character data 515.

FIG. 11 is a block diagram showing a configuration example of the emphasis degree setting unit 610.

As shown in FIG. 11, the emphasis degree setting unit 610 includes an emotion setting unit 612, a sentiment setting unit 613, a character setting unit 615, and an emphasis degree integration unit 630.

The emotion setting unit 612 sets an emotion emphasis degree 622 on the basis of the emotion data 512. For example, the emotion setting unit 612 sets the emphasis degree to be higher in a case where the reliability of joy or anger is higher and sets the emphasis degree to be lower in a case where the reliability of fear or sadness is higher.

The sentiment setting unit 613 sets a sentiment emphasis degree 623 on the basis of the sentiment data 513. For example, the sentiment setting unit 613 sets the emphasis degree to be higher in a case where the positive reliability is higher and sets the emphasis degree to be lower in a case where the negative reliability is higher.

The character setting unit 615 sets a character emphasis degree 625 on the basis of the character data 515. For example, the character setting unit 615 sets the emphasis degree to be higher in a case where the age of the speaker is lower and sets the emphasis degree to be lower in a case where the age of the speaker is higher. Moreover, for example, in a case where the character data includes Big Five personality traits, the emphasis degree is set to be high when the reliability indicating extroversion is high. That is, the motions of the gestures are made lively and intense (“Generation of Agent Gestures that Express Personality Traits,” (see Nakano et al., Human Interface Society Journal, Vol. 23, No. 2, pp. 153-164, 2021”)). On the other hand, in a case where the reliability indicating neuroticism is high, the emphasis is set to be low and is set to vary slightly over time. Accordingly, it is possible to suppress the motions of the gestures and express unstable and awkward motions.

Moreover, in a case where the character data 515 includes a plurality of characters (e.g., gender, age, personality, etc.), the character setting unit 615 integrates them and sets the character emphasis degree 625. Specifically, the emphasis degree for each character may be calculated by weighting the average of the emphasis degrees, multiplying the plurality of emphasis degrees, or using a calculation formula obtained from a subjective evaluation experiment.

The emphasis degree integration unit 630 integrates the three types of emphasis degrees output from the emotion setting unit 612, the sentiment setting unit 613, and the character setting unit 615. For example, the emphasis degree integration unit 630 may integrate the emphasis degrees by weighting the average, multiplication of the plurality of emphasis degrees, or using the calculation formula obtained from the subjective evaluation experiment. The integrated emphasis degree (beat gesture emphasis degree 650) is output to the emphasis unit 400.

It should be noted that in the present embodiment, the beat gesture emphasis degree 650 is set for each joint of a human skeleton. Moreover, different weightings may be assigned to each joint and emphasis degrees may be set on the basis of the motion control information 680 output from the motion determination unit 660 to be described later. For example, in a case where a pose is made in which the right arm is raised and the left arm is lowered while speaking, it is assumed that the right arm and right hand will be moved greatly, so the weighting of each joint (right shoulder, right elbow, right wrist, fingers, or the like) is set to be large, and the weighting of the left arm is set to be small.

The motion determination unit 660 sets the motion control information 680 on the basis of the speech division data 511, the emotion data 512, the keyword data 514, and the character data 515.

The motion control information 680 is information indicating pose data for animation reproduction. In the present embodiment, the motion control information 680 is information obtained by integrating timing information 671 output from a switching timing setting unit 661 to be described later and motion type information 672 output from a motion selection unit 662.

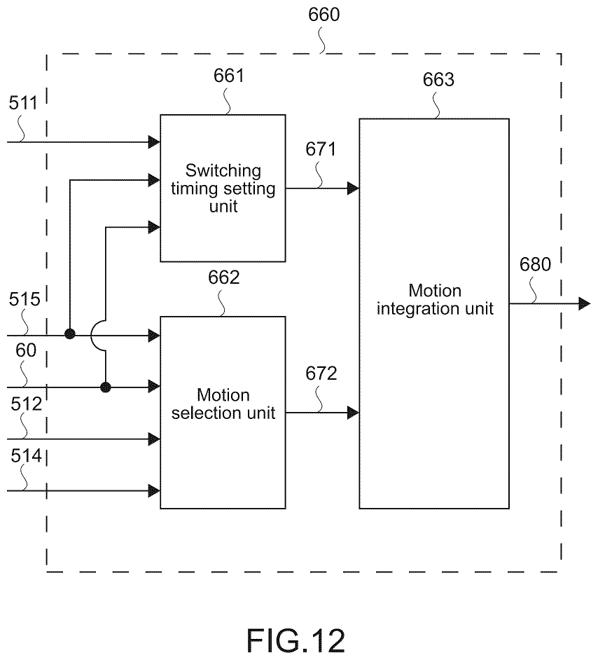

FIG. 12 is a block diagram showing a configuration example of the motion determination unit.

As shown in FIG. 12, the motion determination unit 660 includes the switching timing setting unit 661, the motion selection unit 662, and a motion integration unit 663.

The switching timing setting unit 661 measures the cumulative time for determining the switching of the motion on the basis of the speech division data 511. Moreover, the switching timing setting unit 661 outputs the timing (the timing indicating the next speech division data 511) at which the above-mentioned cumulative time exceeds a predetermined threshold as the timing information 671. That is, the timing information 671 is the time at which the cumulative time satisfies the predetermined threshold, or in other words, it is information about the timing of switching between the speech division data and the next speech division data.

It should be noted that in a case where the reliability of the neuroticism in the input character data 515 is equal to or larger than a predetermined threshold, a small error may be added randomly to the value of the timing information. Accordingly, since the gesture is switched at an awkward timing, it is possible to express the motion of the neuroticism.

On the basis of the emotion data 512, the keyword data 514, and the character data 515, the motion selection unit 662 sets the motion type information 672 that is information selecting a pre-set fixed motion (hereinafter, referred to as motion clip).

In the present embodiment, in a case where word(s) corresponding to a keyword pre-registered in the keyword data 514 is included, the motion selection unit 662 selects a motion clip corresponding to that keyword. For example, the motion clip includes a motion using the whole body, such as a bow, or a hand signal, such as a peace sign. Typically, the motion clip includes a motion that shows a common meaning in a region, country, or the like.

It should be noted that words corresponding to motion clips may be set arbitrarily. For example, in a case of words containing the keyword “thank you,” a bow may be selected. Moreover, in a case of words containing a keyword indicating a number such as “two,” a sign raising fingers corresponding to that number (e.g., a peace sign) may be selected.

Also, in a case where word(s) corresponding to the keyword pre-registered in the keyword data 514 is not included, the motion selection unit 662 selects a motion included in the motion generation data 212, not the motion clip. In the present embodiment, on the basis of the emotion data 512 and the character data 515, the motion selection unit 662 selects a gesture corresponding to the low-frequency information 306 output from the division unit 300.

Specifically, a table is defined in which the poses actually performed by a performer are captured in advance and a reliability value for each of emotion, gender, age, and personality is assigned to each pose. For example, the table is defined as follows.

### Pose Name: A

Emotion (joy: 0.9, anger: 0.1, fear: 0.05, surprise: 0.4, disgust: 0.09, sadness: 0.08)
Sentiment (positive: 0.8, negative: 0.1, neutral: 0.4)
Character (male: 0.8, female: 0.2, young ages: 0.6, middle ages: 0.33, older ages: 0.07, openness: 0.54, agreeableness: 0.31, conscientiousness: 0.13, extraversion: 0.73, neuroticism: 0.09)

The pose with the smallest sum of errors between these numeric values of the reliability of the emotion, sentiment, and character and the numeric values of the reliability output from the emotion recognition unit, the speech analysis unit, and the character analysis unit is selected.

It should be noted that the method of assigning reliability when defining the table is not limited, and may be set on the basis of subjective evaluation.

Here, the poses actually performed by the performer refer to poses performed by performers with various individual characteristics included in character data such as gender, age, and personality, for each of a plurality of predetermined poses representing emotions included in emotion data such as joy, anger, fear, surprise, disgust, or sadness. For example, a male performer who is 20 years old and has a cheerful personality performs a pose or the like representing joy by raising both hands, and that pose is captured.

That is, the motion type information 672 includes selection information for reproducing either a fixed motion (motion clip) corresponding to a pre-registered keyword or a motion included in the motion generation data 212. In the present embodiment, the motion type information 672 is output to the motion integration unit 663.

The motion integration unit 663 integrates the timing information 671 output from the switching timing setting unit 661 and the motion type information 672 output from the motion selection unit 662, and outputs them as motion control information 680.

It should be noted that in a case where the scenario is fixed depending on a use case, the timing information 671 and the motion type information 672 may be forcibly set in accordance with a scenario 60 specified by the user.

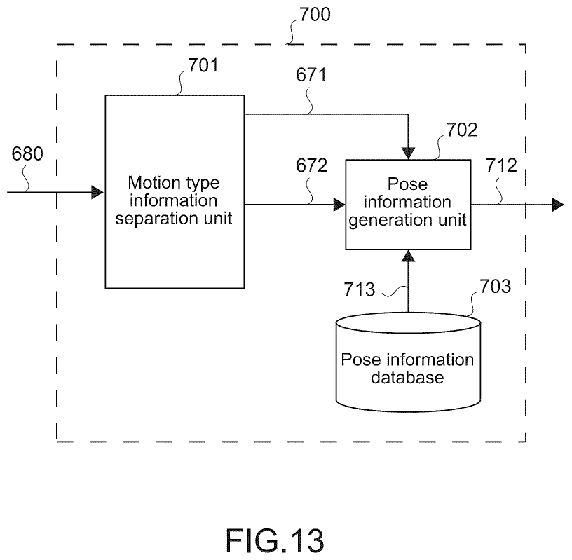

The pose information setting unit 700 outputs the pose information 712 on the basis of the input motion control information 680. Specifically, it will be described with reference to FIG. 13.

FIG. 13 is a block diagram showing a configuration example of the pose information setting unit 700.

As shown in FIG. 13, the pose information setting unit 700 includes a motion type information division unit 701, a pose information generation unit 702, and a pose information database 703.

The motion type information division unit 701 divides the timing information 671 and the motion type information 672 from the input motion control information 680. In the present embodiment, the timing information 671 and the motion type information 672 are output to the pose information generation unit 702.

The pose information generation unit 702 searches for data stored in the pose information database 703 and obtains the corresponding data 713 in a case where the motion type information 672 includes information indicating replacement pose data for animation reproduction using the motion. Moreover, the pose information generation unit 702 outputs the data 713 obtained from the above-mentioned pose information database 703 as pose information 712 at the timing indicated by the timing information 671.

Moreover, the pose information generation unit 702 sets the data indicating the invalidity to be applied to the pose information 712 in a case where the motion type information 672 includes information indicating the reproduction of the motion clip. Moreover, the pose information generation unit 702 sets the identification data to be applied to the pose information 712 in a case where the motion type information 672 is identification data indicating the low-frequency information.

The motion clip setting unit 800 outputs motion clip information 812 on the basis of the input motion control information 680.

The motion clip information 812 is information indicating the motions of the various parts such as the face, head, arms, and legs of a person in a pre-set fixed motion. For example, the motion clip information 812 includes information controlling the operation such as how much to move various parts and how many times to rotate each joint.

Moreover, the motion clip information 812 may be set with the time until the predetermined motion is reached. For example, in a case where a predetermined motion is performed in two seconds from an initial state (e.g., standing upright), the time allocation for performing predetermined operations of various parts and joints, such as the speed and acceleration of raising the hands, may be set. As a matter of course, upper limit values may be set in order to reproduce realistic motions.

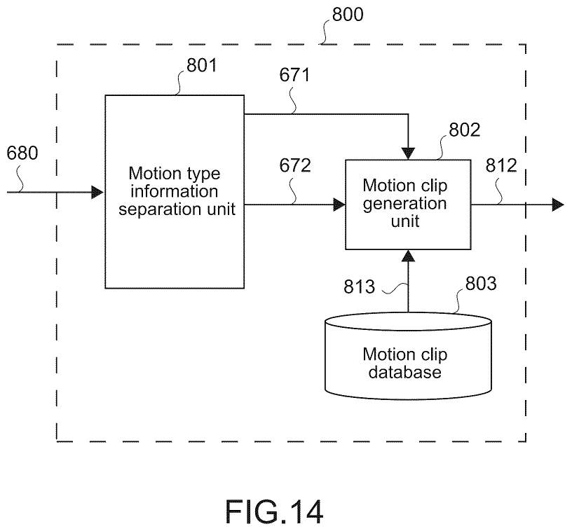

FIG. 14 is a block diagram showing a configuration example of the motion clip setting unit 800.

As shown in FIG. 14, the motion clip setting unit 800 includes a motion type information division unit 801, a motion clip generation unit 802, and a motion clip database 803. It should be noted that a description of the motion type information division unit 801 will be omitted because it performs processing similar to the motion type information division unit 701 of the pose information setting unit 700 in FIG. 13.

In a case where the input motion type information 672 includes information indicating the reproduction of the motion clip, the motion clip generation unit 802 searches for data stored in the motion clip database 803 and obtains the corresponding data 813. Moreover, the motion clip generation unit 802 outputs the data 813 obtained from the above-mentioned pose information database 803 as motion clip information 812 at the timing indicated by the timing information 671.

Moreover, the motion clip generation unit 802 sets data indicating invalidity (e.g., data in which all rotation angles indicating joint motions are set to values outside the definition range) to be applied to the motion clip information 812 in a case where the motion type information 672 indicates reproduction of a motion included in the motion generation data 212.

The reproduction control unit 900 applies the motion determined in accordance with the post-motion generation information 440 and the motion clip information 812 to the model information 65 to which an additionally input animation is applied. Moreover, the reproduction control unit 900 outputs the animation reproduction data 912 in which the 3D character model set in the model information 65 changes (operates) in a time series.

In the present embodiment, the reproduction control unit 900 outputs the collision information 913 to the emphasis unit 400 so as to feed back the collision information. The emphasis unit 400 adjusts the applied beat gesture emphasis degree 650 and controls so that no mesh collision occurs.

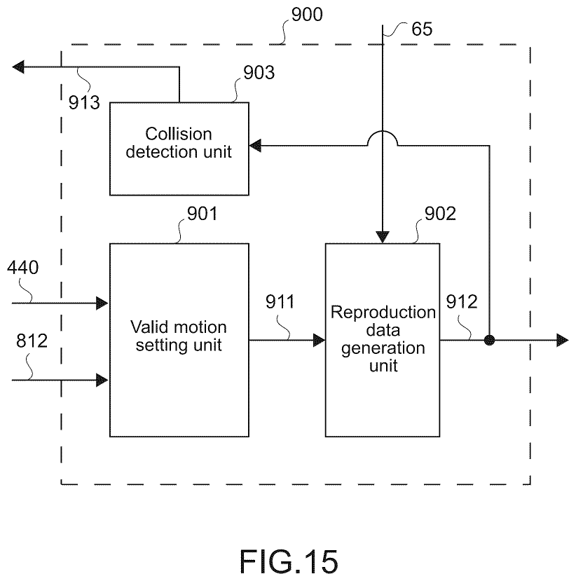

FIG. 15 is a block diagram showing a configuration example of the reproduction control unit 900.

As shown in FIG. 15, the reproduction control unit 900 includes a valid motion setting unit 901, a reproduction data generation unit 902, and a collision detection unit 903.

The valid motion setting unit 901 outputs either the post-motion generation information 440 or the motion clip information 812 to the reproduction data generation unit 902. Specifically, since either the post-motion generation information 440 or the motion clip information 812 is always data indicating invalidity, the data indicating the invalidity is ignored, and the data indicating the validity of the other is output. Hereinafter, data indicating the validity of either the post-motion generation information 440 or the motion clip information 812 will be referred to as validity data 911.

The reproduction data generation unit 902 applies the validity data 911 to the input model information 65 and generates the animation reproduction data 912.

The collision detection unit 903 determines whether the mesh collision has occurred with respect to the mesh data included in the input animation reproduction data 912. In the present embodiment, the collision detection unit 903 outputs the collision information 913 to the emphasis unit 400 as information indicating whether or not a collision has occurred and a location where a collision has occurred.

It should be noted that the collision detection unit 903 in the present embodiment corresponds to a detection unit that determines whether the avatar has collided.

The emphasis unit 400 attenuates the value of the beat gesture emphasis degree 650 on the basis of the collision information 913. Accordingly, the mesh collision is prevented.

It should be noted that the collision determination method is not limited, and for example, a technology such as “FCL: A general purpose library for collision and proximity queries (Jia Pan et al. 2012)” may be used.

It should be noted that the motion generation unit 600 and the pose information setting unit 700 in the present embodiment correspond to a control unit that controls the correction parameter on the basis of the speech information.

Hereinabove, the information processing apparatus 1 according to the present embodiment infers motion generation data 212 by inputting the voice data into the motion generation model 13, such that the motion generation data 212 is divided into a high-frequency component that represents beat gestures 307 corresponding to the conversation rhythm and low-frequency information 306 representing gestures different from the beat gestures 307. Moreover, the post-motion generation information 440 is generated by correcting at least one of the high-frequency component and the low-frequency component on the basis of beat gesture emphasis degree 650, pause information 712, and collision information 913. Accordingly, it is possible to realize diverse expressions of gestures and improve the control accuracy of the gestures.

Conventionally, a technique for changing mouth motions on the basis of a voice is known. However, since the same speech voice may produce different motions, there has been a problem in that the mouth motions output from the inference processing tends to be average motions of learning data.

In a speech-driven gesture generation method of generating a gesture on the basis of the voice according to the present technology, when generating human motions (speech, facial expressions, gestures, or the like) from voice data using deep learning, the time-series data of the pose of the human skeleton output from the inference processing is divided into low-frequency and a high-frequency component in the time direction as post-processing, and high-frequency component emphasis processing and low-frequency component replacement processing are applied. This makes it possible to increase the learning data and enable diverse expressions with only inference-side processing, without changing the learning processing. Moreover, the magnitude of the motions of the gestures can be controlled, enabling the expression of motions in various poses.

Also, in the present technology, an effect that makes the motions of dialogue feel natural by analyzing input voice data and generating motions that match the speaker and speech contents at the time of the speech can be provided.

Furthermore, unnatural animation reproduction can be prevented by controlling the motion generation processing for each local part of a person in accordance with whether or not there are collisions of meshes during the animation reproduction.

Moreover, as an application of the present embodiment, remote customer support operations and the like can be considered. For example, by having a customer service operator respond only by voice without showing his or her appearance, it is possible to protect the privacy of the operator and realize efficiency in customer service while performing tasks such as keyboard operations. Moreover, on the customer side, it is possible to provide an experience close to face-to-face service because the customer can receive service through an avatar displayed as an animation generated by speech-driven motion.

### Second Embodiment

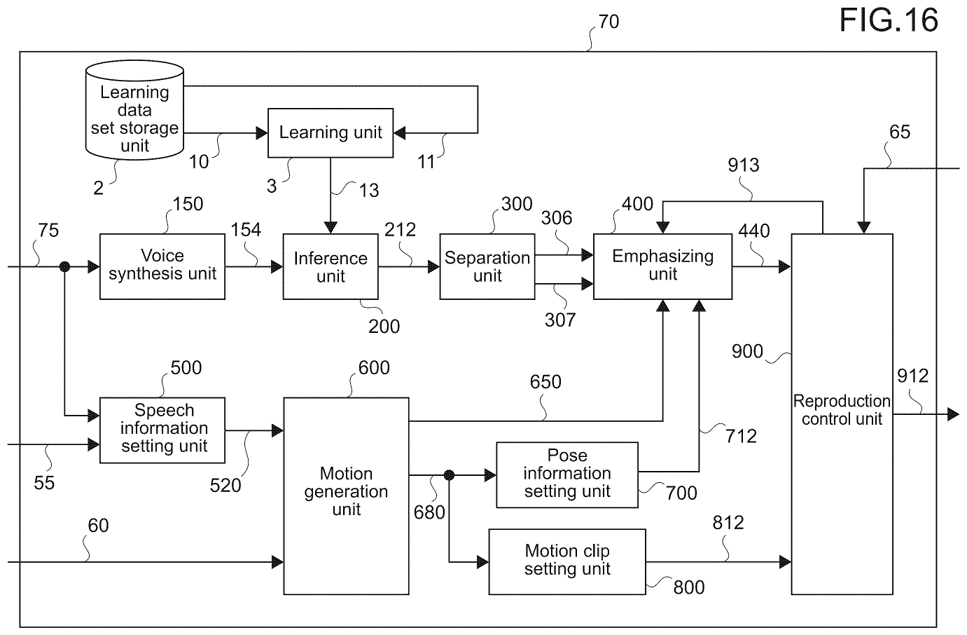

FIG. 16 is a block diagram showing a configuration example of an information processing apparatus according to a second embodiment of the present technology. Hereinafter, the description of parts that are similar to the configuration and action of the information processing apparatus described in the above-mentioned embodiment will be omitted or simplified. Moreover, for the sake of simplicity, reference signs similar to those used in the information processing apparatus described in the above-mentioned embodiment may be used in the present embodiment, but the configuration is not necessarily limited to the above-mentioned embodiment.

As shown in FIG. 16, an information processing apparatus 70 includes a voice synthesis unit 150 instead of the voice data processing unit 100.

The voice synthesis unit 150 synthesizes a voice on the basis of text test data 75 input in place of the voice test data 50, which is an actual voice. The synthesized speech 154 is output to the inference unit 200. It should be noted that the text test data 75 includes text information indicating the generation of silent periods, which are periods between utterances, in accordance with the specifications of a text-to-speech (TTS) processing unit 152 to be described later.

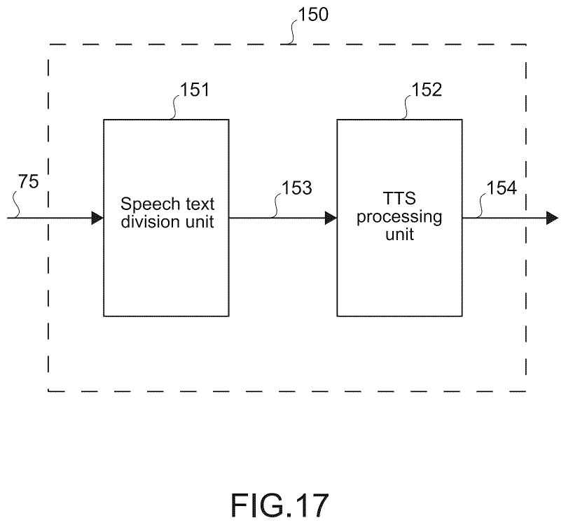

FIG. 17 is a block diagram showing a configuration example of the voice synthesis unit 150.

As shown in FIG. 17, the voice synthesis unit 150 includes a speech text division unit 151 and a TTS processing unit 152.

The speech text division unit 151 performs morphological analysis of the text test data 75 using natural language processing and counts the number of characters. In the present embodiment, the speech text division unit 151 detects and divides sentence boundaries with priority given to the points immediately before the occurrence of conjunctions, under the condition that the total number of characters counted falls within a predetermined range. The divided text 153 is output to the TTS processing unit 152.

The TTS processing unit 152 performs text-to-speech processing. In the present embodiment, the TTS processing unit 152 uses a technology such as Voice-Clone (e.g., “Deep Voice 3: Scaling text-to-speech with Convolutional Sequence Learning, ” Wei Ping et al., (2017)) to approximate the voice quality of the speaker used in the learning data.

Accordingly, it is unnecessary to change the data set on the learning side or to execute re-learning, and the motion generation model learned with actual voice can be used as it is. Moreover, since the functions of the voice data processing unit 100 are included in the voice synthesis unit 150, it is unnecessary to provide the voice data processing unit 100.

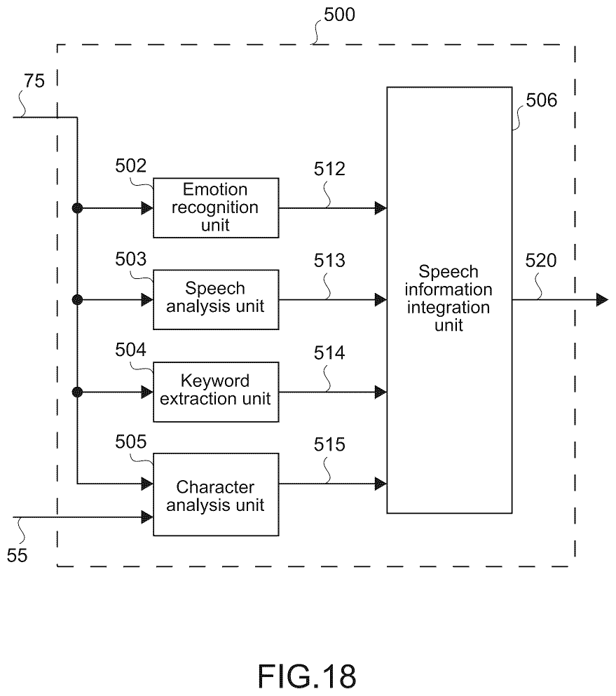

FIG. 18 is a block diagram showing a configuration example of the speech information setting unit 500.

As shown in FIG. 18, the speech information setting unit 500 includes the emotion recognition unit 502, the speech analysis unit 503, the keyword extraction unit 504, the character analysis unit 505, and the speech information integration unit 506. In FIG. 18, since there is no need for processing to divide the voice data, there is also no need for a speech division unit 501 or speech-to-text processing in each block.

For example, in the present embodiment, the emotion recognition unit 502 recognizes the emotion of the speaker (text) by using a text-based emotion recognition technology such as the method described in, for example, “Text-based emotion detection: Advances, challenges, and opportunities.,” Francisca Adoma Acheampong1 et al. (Computer Science Engineering Reports 2020).

Moreover, for example, the character analysis unit 505 analyzes characters by using text-based recognition technologies such as those described in “Age and Gender prediction in Open Domain Text,” Emad E. Abdallah et al. (Procedia Computer Science, 2020) and “Attempts and considerations for utilizing writer's personality trait information estimated from text (Nasukawa et al., Language Processing Society of Japan 26th Annual Meeting Proceedings (2020)).”

Accordingly, even if there is no person who has spoken the voice data used for learning, or even if the voice of that person cannot be obtained during inference, it is possible to generate motions from various dialogue voice data by using synthesized voice that is close to the voice quality used for learning. That is, it can be applied to AI agent services that use animated expressions of virtual characters.

### Third Embodiment

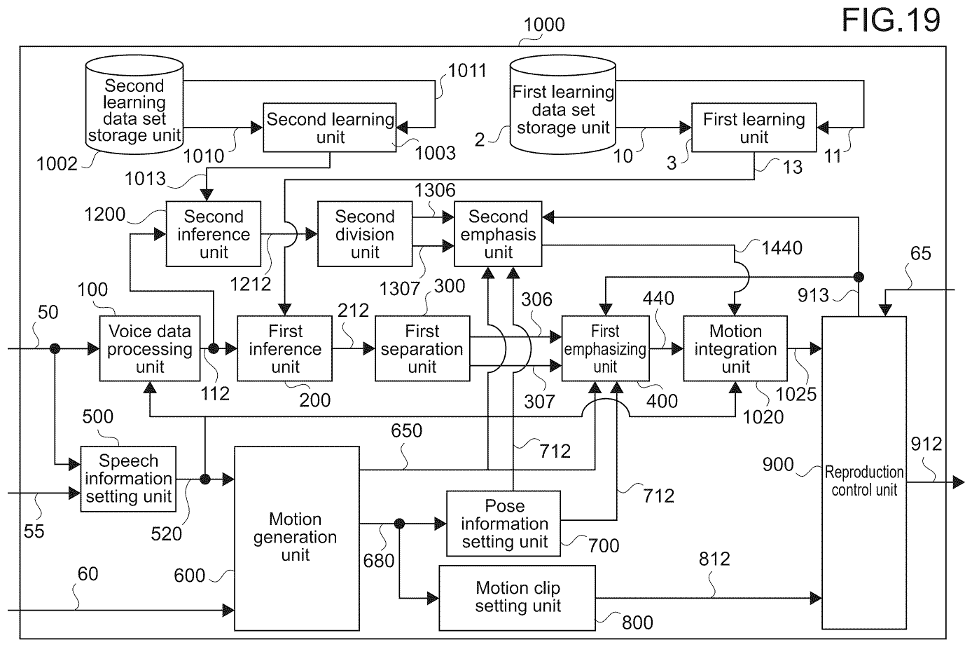

FIG. 19 is a block diagram showing a configuration example of an information processing apparatus 1000 according to a third embodiment of the present technology.

In FIG. 19, blocks and data similar to those of the information processing apparatus 1 shown in FIG. 1 may be described as “first.” For example, the learning data set storage unit 2, the learning unit 3, the inference unit 200, the division unit 300, and the emphasis unit 400 are described as a first learning data set storage unit 2, the first learning unit 3, the first inference unit 200, the first division unit 300, and the first emphasis unit 400. Similarly, the blocks and data added in FIG. 19 may be described as “second.” Moreover, the blocks and data added in the present embodiment (such as beat gestures and low-frequency information) are assigned reference signs in the 1000 series. For example, the reference sign 1306 shown in FIG. 19 means low-frequency information 1306.

As shown in FIG. 19, the information processing apparatus 1000 includes a second learning data set storage unit 1002, a second learning unit 1003, a second inference unit 1200, a second division unit 1300, a second emphasis unit 1400, and a motion integration unit 1020 in addition to the first learning data set storage unit 2, the first learning unit 3, the voice data processing unit 100, the first inference unit 200, the first division unit 300, the first emphasis unit 400, the speech information setting unit 500, the motion generation unit 600, the pose information setting unit 700, the motion clip setting unit 800, and the reproduction control unit 900.

That is, in the third embodiment, different learning processing is performed during learning. Specifically, a data set of pairs of second voice data 1010 and second motion information 1011 is stored in the second learning data set storage unit 2. It should be noted that the second voice data 1010 is voice data uttered by the same person as the first voice data 10. Moreover, the second motion information 1011 is generated from the performance of the same person as the first motion information 11.

In the third embodiment, characteristics of the second voice data 1010 and the second motion information 1011 are created so as to be different from those of the first voice data and the first motion information.

Specifically, voice data and motion information when a line with high reliability of joy or anger is spoken are set as the first voice data 10 and the first motion information 11 by the emotion recognition unit 502. Moreover, voice data and motion information when a line with higher positive reliability is spoken are set as the first voice data 10 and the first motion information 11 by the speech analysis unit 503.

On the other hand, voice data and motion information when a line with high reliability of fear or sadness is spoken are set as the second voice data 1010 and the second motion information 1011 by the emotion recognition unit 502. Moreover, voice data and motion information when a line with higher negative reliability is spoken are set as second voice data 1010 and second motion information 1011 by the speech analysis unit 503.

In this manner, learning processing is performed using two types of data sets, and two types of motion generation models are generated. That is, the first learning unit 3 generates first motion generation model 13 and outputs it to the first inference unit 200. Moreover, the second learning unit 1003 generates second motion generation model 1013 and outputs it to the second inference unit 1200.

As in the first post-motion generation information 440 inferred by the first inference unit 200, the second inference unit 1200 infers second post-motion generation information 1440 on the basis of the second motion generation model 1013.

The motion integration unit 1020 generates third post-motion generation information 1025 on the basis of the first post-motion generation information 440 and the second post-motion generation information 1440, the emotion data 512, and the sentiment data 513.

Specifically, the first post-motion generation information 440 and the second post-motion generation information 1440 are integrated in accordance with each reliability of emotion data, such as joy, anger, fear, surprise, disgust, or sadness, and each reliability of sentiment data, such as positive, negative, or neutral.

Moreover, the motion integration unit 1020 may output either the first post-motion generation information 440 or the second post-motion generation information 1440 as the third post-motion generation information 1025. For example, in a case where the joy, anger, and positive reliability are determined to be high, the first post-motion generation information 440 may be output as the third post-motion generation information 1025. Moreover, for example, in a case where the fear, sadness, and negative reliability is determined to be high, the second post-motion generation information 1440 may be output as the third post-motion generation information 1025.

It should be noted that the number of learning units and the number of inference units corresponding to the learning units are not limited, and a plurality of learning data set storage units and a plurality of learning units may be used.

As shown in the first embodiment, in a case where only one type of motion generation model is used, there has been a problem in that the cycle of the beat motion tends to become monotonous. However, in the third embodiment, since beat motion is generated in accordance with emotion data and sentiment data from two types of motion generation models generated using the network structure as it is, it is possible to express more varied motions.

### Other Embodiments

The present technology is not limited to the above-mentioned embodiments, and various other embodiments can be realized.

In the above-mentioned embodiments, the post-motion generation information 440 is applied to the model information 65, which is a virtual object. The present technology is not limited thereto, and may also be applied to label data used in deep learning image generation techniques (e.g., “Video-to-Video Synthesis” (2018)).

The respective configurations such as the inference unit, the division unit, the motion generation unit, the emphasis unit, and the like, which have been described with reference to the respective drawings, are merely embodiments, and can be arbitrarily modified without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be arbitrarily combined across the respective embodiments.

It should be noted that the present technology can also take the following configurations.
(1) An information processing apparatus, including:
   an inference unit that infers gesture information related to a gesture by inputting voice data to a learned model;
   a division unit that divides the gesture information into a high-frequency component that represents a beat gesture corresponding to a conversation rhythm and a low-frequency component that represents a gesture different from the beat gesture; and
   a correction unit that generates corrected gesture information by correcting at least one of the high-frequency component or the low-frequency component on the basis of a correction parameter.
(2) The information processing apparatus according to (1), further including
   a reproduction control unit that synchronizes the corrected gesture information with the voice data and causes an avatar to perform the gesture based on the corrected gesture information.
(3) The information processing apparatus according to (1), in which
   the correction parameter includes at least one of an emphasis degree indicating a degree of emphasizing the beat gesture, replacement information that causes the avatar to perform a predetermined gesture, or collision information related to a collision of the avatar.
(4) The information processing apparatus according to (3), in which
   the correction unit emphasizes the beat gesture on the basis of the emphasis degree.
(5) The information processing apparatus according to (4), in which
   the correction unit adds the beat gesture emphasized on the basis of the emphasis degree to a gesture represented by the low-frequency component.
(6) The information processing apparatus according to (4), in Which
   the correction unit replaces a gesture represented by the low-frequency component on the basis of the replacement information.
(7) The information processing apparatus according to (1), in which
   a gesture represented by the low-frequency component includes a gesture accompanied by speech and a gesture indicating a feature of a time direction or a spatial direction.
(8) The information processing apparatus according to (1), further including
   a setting unit that sets speech information related to a speaker who utters speech on the basis of the voice data.
(9) The information processing apparatus according to (8), in which
   the speech information includes at least one of an emotion of the speaker in the speech, a sentiment of the speaker in the speech, a keyword included in the speech, or a character of the speaker in the speech.
(10) The information processing apparatus according to (9), further including
   a control unit that controls a correction parameter on the basis of the speech information, in which
   the control unit controls an emphasis degree on the basis of at least one of the emotion, the sentiment, or the character.
(11) The information processing apparatus according to (9), in which
   the control unit controls a timing of replacing a gesture represented by the low-frequency component on the basis of a timing at which the keyword is uttered.
(12) The information processing apparatus according to (3), further including
   a detection unit that determines whether the avatar is colliding, in which
   the collision information includes information as to whether or not the avatar is colliding and information about a position where the collision is occurring.
(13) The information processing apparatus according to (12), in which
   the correction unit attenuates the emphasis degree so that the collision does not occur on the basis of the collision information.
(14) An information processing method, including:
   by a computer system,
   inferring gesture information related to a gesture by inputting voice data to a learned model;
   dividing the gesture information into a high-frequency component that represents a beat gesture corresponding to a conversation rhythm and a low-frequency component that represents a gesture different from the beat gesture; and
   generating corrected gesture information by correcting at least one of the high-frequency component or the low-frequency component on the basis of a correction parameter.
(15) A recording medium recording a program that causes a computer system to execute the steps of:
   inferring gesture information related to a gesture by inputting voice data to a learned model;
   dividing the gesture information into a high-frequency component that represents a beat gesture corresponding to a conversation rhythm and a low-frequency component that represents a gesture different from the beat gesture; and
   generating corrected gesture information by correcting at least one of the high-frequency component or the low-frequency component on the basis of a correction parameter.

### REFERENCE SIGNS LIST

1 information processing apparatus
13 motion generation model
200 inference unit
212 motion generation data
300 division unit
306 low-frequency information
307 beat gesture
400 emphasis unit
440 post-motion generation information
500 speech information setting unit
520 speech information
600 motion generation unit
650 beat gesture emphasis degree
712 pose information
900 reproduction control unit
913 collision information

1. An information processing apparatus, comprising:
an inference unit that infers gesture information related to a gesture by inputting voice data to a learned model;
a division unit that divides the gesture information into a high-frequency component that represents a beat gesture corresponding to a conversation rhythm and a low-frequency component that represents a gesture different from the beat gesture; and
a correction unit that generates corrected gesture information by correcting at least one of the high-frequency component or the low-frequency component on a basis of a correction parameter.

2. The information processing apparatus according to claim 1, further comprising
a reproduction control unit that synchronizes the corrected gesture information with the voice data and causes an avatar to perform the gesture based on the corrected gesture information.

3. The information processing apparatus according to claim 1, wherein
the correction parameter includes at least one of an emphasis degree indicating a degree of emphasizing the beat gesture, replacement information that causes the avatar to perform a predetermined gesture, or collision information related to a collision of the avatar.

4. The information processing apparatus according to claim 3, wherein
the correction unit emphasizes the beat gesture on a basis of the emphasis degree.

5. The information processing apparatus according to claim 4, wherein
the correction unit adds the beat gesture emphasized on a basis of the emphasis degree to a gesture represented by the low-frequency component.

6. The information processing apparatus according to claim 4, wherein
the correction unit replaces a gesture represented by the low-frequency component on a basis of the replacement information.

7. The information processing apparatus according to claim 1, wherein
a gesture represented by the low-frequency component includes a gesture accompanied by speech and a gesture indicating a feature of a time direction or a spatial direction.

8. The information processing apparatus according to claim 1, further comprising
a setting unit that sets speech information related to a speaker who utters speech on a basis of the voice data.

9. The information processing apparatus according to claim 8, wherein
the speech information includes at least one of an emotion of the speaker in the speech, a sentiment of the speaker in the speech, a keyword included in the speech, or a character of the speaker in the speech.

10. The information processing apparatus according to claim 9, further comprising
a control unit that controls a correction parameter on a basis of the speech information, wherein
the control unit controls an emphasis degree on a basis of at least one of the emotion, the sentiment, or the character.

11. The information processing apparatus according to claim 9, wherein
the control unit controls a timing of replacing a gesture represented by the low-frequency component on a basis of a timing at which the keyword is uttered.

12. The information processing apparatus according to claim 3, further comprising
a detection unit that determines whether the avatar is colliding, wherein
the collision information includes information as to whether or not the avatar is colliding and information about a position where the collision is occurring.

13. The information processing apparatus according to claim 12, wherein
the correction unit attenuates the emphasis degree so that the collision does not occur on a basis of the collision information.

14. An information processing method, comprising:
by a computer system,
inferring gesture information related to a gesture by inputting voice data to a learned model;
dividing the gesture information into a high-frequency component that represents a beat gesture corresponding to a conversation rhythm and a low-frequency component that represents a gesture different from the beat gesture; and
generating corrected gesture information by correcting at least one of the high-frequency component or the low-frequency component on a basis of a correction parameter.

15. A recording medium recording a program that causes a computer system to execute the steps of:
inferring gesture information related to a gesture by inputting voice data to a learned model;
dividing the gesture information into a high-frequency component that represents a beat gesture corresponding to a conversation rhythm and a low-frequency component that represents a gesture different from the beat gesture; and
generating corrected gesture information by correcting at least one of the high-frequency component or the low-frequency component on a basis of a correction parameter.
